(19) United States
(12) Patent Application Publication
(10) Pub. No.: US 2023/0145710 A1
(43) Pub. Date: May 11, 2023

(54) LASER RECEIVING DEVICE, LIDAR, AND INTELLIGENT INDUCTION APPARATUS

(71) Applicant: SUTENG INNOVATION TECHNOLOGY CO., LTD., Shenzhen (CN)

(72) Inventors: Jianming XIONG, Shenzhen (CN); Ying YANG, Shenzhen (CN)

(73) Assignee: SUTENG INNOVATION TECHNOLOGY CO., LTD., Shenzhen (CN)

(21) Appl. No.: 18/093,781

(22) Filed: Jan. 5, 2023

Related U.S. Application Data
(63) Continuation of application No. PCT/CN2020/100705, filed on Jul. 7, 2020.

(51) Int. Cl. G01S 7/481

(52) U.S. Cl. CPC G01S 7/4816

(57) ABSTRACT

A laser receiving device includes a laser receiving plate, a laser receiving unit, and a first emitting optical adjustment unit. The laser receiving unit is arranged on the surface of the laser receiving plate for receiving echo laser signals. The first emitting optical adjustment unit is arranged on one side of the laser receiving unit for adjusting emission directions of laser beams entering an optical surface of the first receiving optical adjustment unit to the laser receiving unit.

### CROSS-REFERENCE TO RELATED APPLICATION

The present application is a continuation of International Application No. PCT/CN2020/100705, filed on Jul. 7, 2020, the content of which is incorporated herein by reference in its entirety.

### TECHNICAL FIELD

The present disclosure relates to the technical field of LiDAR, and more particularly, to a laser receiving device, a LiDAR, and an intelligent induction apparatus.

### BACKGROUND

With the development of technology, LiDAR is widely used in the fields of intelligent equipment such as autonomous drive, intelligent robot navigation, unmanned aerial vehicle, and the like, and is used in scenarios such as environment detection and spatial modeling. The LiDAR is a radar system that emits a laser beam to detect the position and speed of a target object. The working principle of LiDAR is to first emit a detection laser beam to the target object, then compare received laser signals reflected from the target object with transmitted signals, and process the signals to obtain relevant information of the target object, such as target distance, azimuth, height, speed, attitude, and shape parameters.

Currently, most mechanical LiDARs are off-axis systems (that is, an emitting system and a receiving system are on different axes). To meet detection requirements, a laser emitting beam and the field of view of a detector are aligned at a long distance. Therefore, when detecting an object at a close distance, a LiDAR detector often cannot receive signal light reflected from the target, or the received signal light is relatively weak, which causes the mechanical LiDAR to fail to accurately detect the object at a close distance.

### SUMMARY

In view of the foregoing problems, an embodiment of the present disclosure provides a laser receiving device, a LiDAR, and an intelligent apparatus to solve the problem of detection of an object at a close distance by a mechanical LiDAR in the prior art.

The embodiment of the present disclosure provides a laser receiving device, comprising a laser receiving plate, a laser receiving unit, and a first receiving optical adjustment unit. The laser receiving unit is arranged on the surface of the laser receiving plate for receiving echo laser signals. The first receiving optical adjustment unit is arranged on the first side of the laser receiving unit for adjusting emission directions of laser beams entering the optical surface of the first receiving optical adjustment unit to the laser receiving unit.

Further, the first receiving optical adjustment unit forms a first preset angle with a plane where the laser receiving plate is positioned.

Further, the first receiving optical adjustment unit forms a second preset angle with a first vertical plane perpendicular to the laser receiving plate.

Further, the first receiving optical adjustment unit is an optical reflecting unit. The optical reflecting unit includes a reflecting plane or a reflecting concave surface.

Further, the laser receiving device includes a first laser receiving array. The first laser receiving array includes a plurality of laser receiving units.

The first receiving optical adjustment unit is arranged on the first side of the laser receiving array for adjusting emission directions of laser beams entering the surface of the first receiving optical adjustment unit to the plurality of the laser receiving units of the laser receiving array.

Further, the laser receiving device further includes a second receiving optical adjustment unit.

The second receiving optical adjustment unit is arranged on the second side of at least one laser receiving unit in the first laser receiving array. The second side of the laser receiving unit is a side opposite to the first receiving optical adjustment unit.

Further, one or more first receiving optical adjustment units are provided.

When one first receiving optical adjustment unit is provided, the first receiving optical adjustment unit is arranged along the first laser receiving array. The length of the projection of the optical surface of the first receiving optical adjustment unit on the laser receiving plate along the laser receiving array is greater than or equal to the total arrangement length of all laser receiving units in the laser receiving array.

When the plurality of first receiving optical adjustment units are provided, the plurality of first receiving optical adjustment units have one-to-one correspondence to the plurality of laser receiving units in the first laser receiving array for adjusting emission directions of laser beams entering each optical reflecting surface of the plurality of first optical units to each laser receiving unit in the first laser receiving array.

Further, an inclination angle of the optical surface of the first receiving optical adjustment unit relative to the laser receiving plate in the horizontal direction is not less than 100 degrees and not more than 115 degrees.

Further, a distance from the first receiving optical adjustment unit to the center of the laser receiving unit is less than 1 mm.

Further, the laser receiving unit further includes an optical grating. The optical grating is arranged on the front side of the laser receiving plate on an echo laser optical path for preventing optical crosstalk generated when the laser receiving unit receives the laser signals.

A hollow structure is arranged on the optical grating. Echo laser is received by the receiving unit via the hollow structure.

The optical surface of the first receiving optical adjustment unit is arranged inside the hollow structure.

Further, a light filter is provided on a laser receiving optical grating.

The light filter is configured to filter incident laser and shoot the incident laser to the laser receiving unit.

An embodiment of the present application provides a laser receiving device, comprising a laser receiving plate, at least two laser receiving arrays, and at least two optical adjustment units.

The at least two laser receiving arrays are arranged on the surface of the laser receiving plate for receiving echo laser signals.

The at least two optical adjustment units have one-to-one correspondence to the at least two laser receiving arrays for adjusting emission directions of laser beams entering each optical surface of the at least two optical adjustment units to the laser receiving array corresponding to each optical surface.

Further, each of the at least two optical adjustment units includes at least one optical surface.

An inclination angle of the optical surface of the optical adjustment unit corresponding to each laser receiving array of the at least two laser receiving arrays in a horizontal direction is different.

Further, the laser receiving array includes the plurality of laser receiving units.

The laser receiving device includes a third receiving optical adjustment unit. The at least two optical adjustment units comprise the third receiving optical adjustment unit.

The third receiving optical adjustment unit forms a third preset angle with a plane where the laser receiving plate is positioned. The third receiving optical adjustment unit forms a fourth preset angle with a second vertical plane perpendicular to the laser receiving plate for adjusting echo laser whose vertical divergence angle is greater than the first preset value in the echo laser.

Further, the laser receiving device further includes an optical grating.

The optical grating is arranged on the front side of the receiving plate on an echo laser optical path. A hollow structure is arranged on the optical grating. The echo laser is received by the receiving unit via the hollow structure.

The optical surfaces of the at least two optical adjustment units are arranged inside the hollow structure.

Further, a light filter is arranged on the laser receiving optical grating.

The light filter is configured to filter incident laser and shoot the incident laser to the laser receiving unit.

An embodiment of the present disclosure provides a LiDAR. The LiDAR includes a laser emitting device and a forgoing laser receiving device.

The laser emitting device includes at least two laser emitting arrays.

The at least two laser emitting arrays have one-to-one correspondence to the at least two laser receiving arrays of the laser receiving device.

Further, the laser emitting device includes a first emitting optical adjustment unit.

The laser emission array includes a plurality of first laser emitting units.

The plurality of first laser emitting units are arranged at the edge of the laser emitting plate for emitting laser signals.

The plurality of first emitting optical adjustment units are arranged in front of the plurality of first laser emitting units respectively for adjusting emission directions and emission angles of the laser signals emitted by the first laser emitting unit.

An embodiment of the present disclosure provides an intelligent sensing apparatus, comprising a LiDAR.

In the embodiment of the present disclosure, an optical adjustment unit is provided for the laser receiving unit to reflect part of light deviating from the laser receiving unit into the photosensitive surface of the laser receiving unit, thereby improving the receiving efficiency of the echo laser signals. Especially when the LiDAR scans an object at a close distance, the laser receiving device provided by the embodiment of the present disclosure has the more remarkable receiving effect of the optical signals.

The foregoing descriptions are only brief descriptions of the technical solutions in the present disclosure. To understand the technical means in the present disclosure more clearly so that the technical means may be carried out according to the content of the specification, and to make the foregoing and other objectives, features, and advantages of the present disclosure more understandable, implementations of the present disclosure are illustrated below.

### BRIEF DESCRIPTION OF DRAWINGS

By reading the detailed description of embodiments below, various other advantages and benefits become clear to the person skilled in the art. The drawings are only used for showing the exemplary embodiments, and are not considered as a limitation to the present disclosure. In addition, throughout the drawings, the same reference signs are used to represent the same component.

FIG. 1 shows a comparison diagram of an incident optical spot of a LiDAR provided by an embodiment of the present disclosure;

FIG. 2 shows an optical path diagram of a laser receiving device provided by an embodiment of the present disclosure;

FIG. 3 shows an optical path diagram of a laser receiving device provided by another embodiment of the present disclosure;

FIG. 4 shows an optical path diagram of a laser receiving device provided by another embodiment of the present disclosure;

FIG. 5 shows a schematic diagram of an optical reflecting unit provided by an embodiment of the present disclosure;

FIG. 6 shows a schematic diagram of the arrangement of an optical reflecting unit provided by an embodiment of the present disclosure;

FIG. 7 shows a schematic structural diagram of the arrangement of a laser receiving array provided by an embodiment of the present disclosure;

FIG. 8 shows a schematic structural diagram of the arrangement of a laser receiving array provided by another embodiment of the present disclosure;

FIG. 9 shows a schematic structural diagram of a receiving device of a LiDAR provided by an embodiment of the present disclosure;

FIG. 10 shows a schematic structural diagram of a receiving device of a LiDAR provided by another embodiment of the present disclosure;

FIG. 11 shows an optical path diagram of a LiDAR provided by an embodiment of the present disclosure;

FIG. 12 shows a diagram of an adjustment optical path of an emitting terminal of a LiDAR provided by an embodiment of the present disclosure; and

FIG. 13 shows a diagram of a reflecting optical path of a receiving terminal of a LiDAR provided by an embodiment of the present disclosure.

### DETAILED DESCRIPTION

Embodiments of the technical solution of the present disclosure are described in detail below in conjunction with the drawings. The following embodiments are only used to describe the technical solutions of the present disclosure more clearly, hence are only used as examples, and cannot be used to limit the protection scope of the present disclosure.

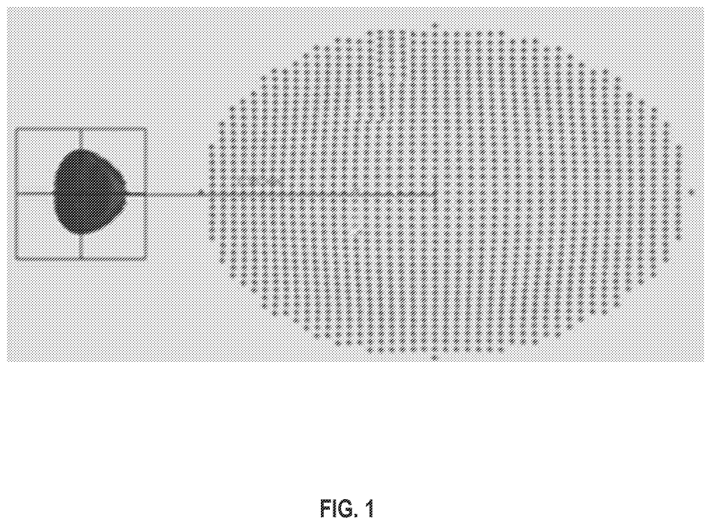

The basic principle of LiDAR is that a laser emits a laser beam. The laser beam is collimated by an emitting optical system and then emitted. The laser beam hits an object and is reflected back to the receiving optical system of the LiDAR and converted into electrical signals. According to whether a laser beam emitting optical system and a laser beam receiving optical system are coaxial, the optical system of the LiDAR may be divided into a coaxial system and an off-axis system. When the emitting optical system and the receiving optical system are on different axes (i.e., the off-axis system), to meet distance measurement requirements, the LiDAR makes a detection field of view of a laser emitting beam be aligned with a receiving field of view of a detector at a long distance. When the distance of an object at a close distance is measured, and when a laser beam emitted by the emitting unit hits the object at the close distance and is reflected, because the emitting optical system and the receiving optical system are aligned at a long distance, reflected signal light passes through a receiving lens and formed an image point, which is not on a focal plane of the receiving lens. After the optical path of the reflected signal light is folded by a mirror at the receiving terminal reflected signals cannot be received by a receiver, thereby causing echo signals at a close distance to be weak and even submerged in noise. Especially, when performing close-distance detection for an object with low reflectivity, such as a black car body, a point cloud generated by the LiDAR based on the laser reflecting signals is very unstable or even undetectable. As shown in FIG. 1, the left small optical spot is an optical spot formed by the reflected laser received by the LiDAR after the LiDAR detects an object at a long distance. The optical spot is very small, and the density is relatively high, which can better enter the surface of a photodetector and generate a better radar point cloud. The right large spot is an optical spot formed by the reflected laser received by the LiDAR after the LiDAR detects the object at a close distance. The optical spot is very large, and the density is relatively low. Further, the energy of the reflected laser entering the surface of the photodetector is very small, which causes a point cloud generated by LiDAR detection to be very unstable or even undetectable.

In view of the above problems, an embodiment of the present disclosure provides a laser receiving device. The laser receiving device may greatly enhance the receiving intensity of reflected echo laser signals of the LiDAR. Especially for the detection of the object at a close distance, the effect is even better, greatly reducing the influence of the problems existing in the related art on LiDAR detection.

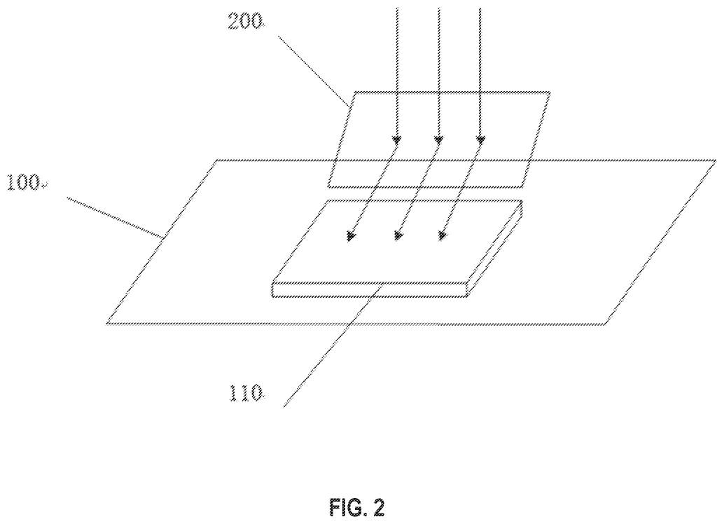

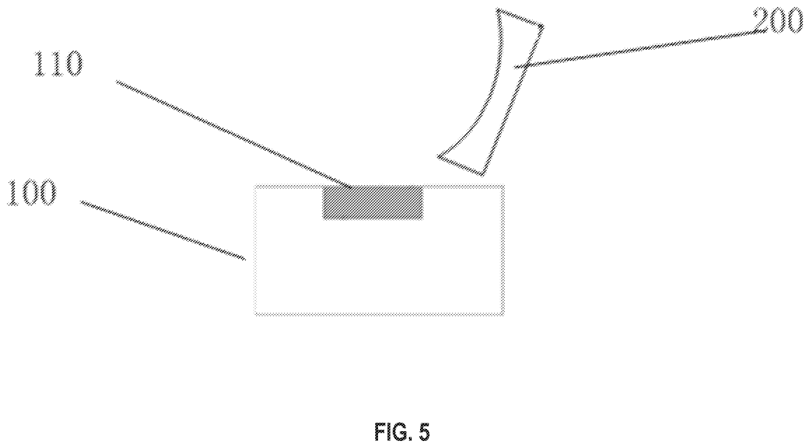

An embodiment of the present disclosure provides a laser receiving device. FIG. 2 shows an optical path diagram of the laser receiving device. The laser receiving device includes a laser receiving plate 100, a laser receiving unit 110, and a first receiving optical adjustment unit 200. The laser receiving unit 110 is arranged on the surface of the laser receiving plate 100 for receiving echo laser signals. The first receiving optical adjustment unit 200 is arranged on one side of the laser receiving unit 110 for adjusting emission directions of laser beams entering the optical surface of the first receiving optical adjustment unit 200 to the laser receiving unit 110. In some embodiments, the first receiving optical adjustment unit 200 forms a first preset angle with a plane where the laser receiving plate 100 is positioned. The first preset angle refers to an inclination angle of the reflecting surface of the first receiving optical adjustment unit 200 relative to the receiving surface of the laser receiving plate 100 and is generally greater than 90 degrees. The laser receiving unit 110 is generally a photoelectric sensor or a photodiode. When the echo laser signals are irradiated on the laser receiving surface of the laser receiving unit 110, the received echo laser signals are converted into electrical signals which are transmitted to the laser receiving plate 100. The laser receiving plate 100 is a circuit plate for processing the received electrical signals. It is understandable that the first receiving optical adjustment unit 200 may be an optical element having a function of changing an optical path, such as one or a combination of two or more of an optical wedge, a microprism, a spherical mirror, or a cylindrical mirror. The first receiving optical adjustment unit 200 may also be a surface with a reflecting function. The surface with the reflecting function may be a reflecting plane or a reflecting concave surface. For example, a flat mirror, or a concave mirror, or may be a polished concave surface with the reflecting function after the surface is polished, as shown in FIG. 5.

As shown in FIG. 2, after a laser beam emitted by a laser emitting terminal is reflected by an object, a part of the incident optical signals may directly enter the surface of the laser receiving unit 110 and he effectively received, a part of the incident optical signals enters outside the surface of the laser receiving unit 110. In some embodiments, the first receiving optical adjustment unit 200 is provided on one side of the laser receiving unit 110 on the laser receiving plate 100, thereby effectively reflecting the echo laser signals deviating from the receiving surface of the laser receiving unit 110 to the surface of the laser receiving unit 110, and increasing the receiving efficiency of the echo laser signals.

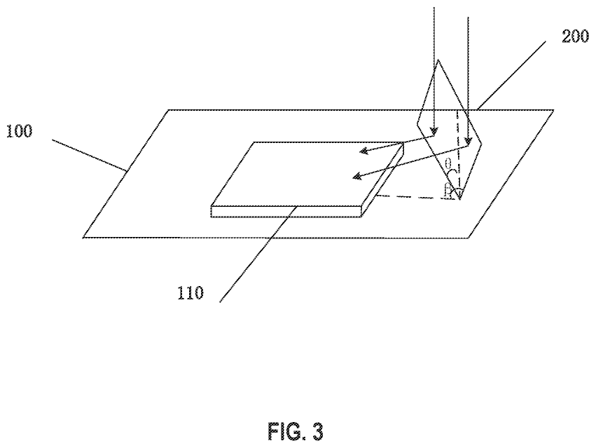

Further, at the laser emitting terminal, because field angles of the emitting units positioned at different places of an emitting plate are different, laser emitted by the laser emitting unit positioned at the edge of the laser emitting plate often has a larger divergence angle. After the signals emitted by the laser emitting unit are reflected by an object to be detected the echo laser signals generated have a larger aberration, resulting in a single direction adjustment of the echo laser at the receiving terminal that can no longer meet receiving requirements. Therefore, to solve the problem that the echo laser signals received by the receiver at the edge are too large to he effectively received by the laser receiving unit, the embodiment of the present application further provides that the first receiving optical adjustment unit 200 is arranged to form the first preset angle with a plane where the laser receiving plate is positioned, and form a second preset angle with a first vertical plane perpendicular to the laser receiving plate at the same time. As shown in FIG. 3, the optical surface of the first receiving optical adjustment unit 200 forms an angle β with the plane where the laser receiving plate 100 is positioned. In addition, the first receiving optical adjustment unit 200 also forms an angle θ with the vertical plane of the laser receiving plate. It is assumed that the laser receiving plate is rectangular. The bottom side of the first receiving optical adjustment unit 200 forms an angle with two adjacent sides of the rectangle. The objective is that the first receiving optical adjustment unit 200 may adjust the echo laser signals of the laser emitting terminal to the laser receiving unit 110 as much as possible, thereby further solving the problem of low receiving efficiency of the echo laser signals.

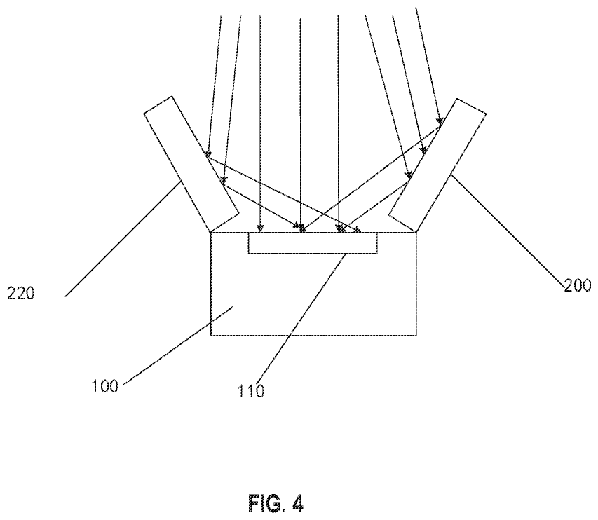

As shown in FIG. 4, two receiving optical adjustment units may he provided, that is, the first receiving optical adjustment unit 200 is arranged on one side of the laser receiving plate, and the second receiving optical adjustment unit 220 is arranged on a side opposite to the first receiving optical adjustment unit 200 of the laser receiving plate. The receiving effect of the echo laser signals may he further improved by this arrangement.

In some embodiments, the first receiving optical adjustment unit and the second receiving optical adjustment unit are optical reflecting units. The optical reflecting unit includes a reflecting flat surface or a reflecting concave surface. As shown in FIG. 5, the reflecting surface may be a concave surface.

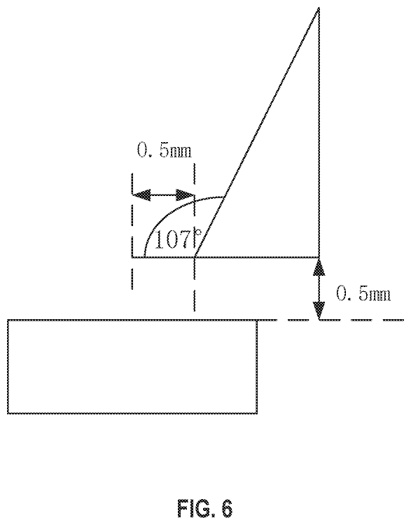

Further, for the arrangement of the first receiving optical adjustment unit, a setting angle of the first receiving optical adjustment unit needs to be adjusted according to the features of the LiDAR. As shown in FIG. 6, an inclination angle of the first receiving optical adjustment unit relative to the plane where the laser receiving plate is positioned is not less than 100 degrees and not more than 115 degree.

A distance from the first receiving optical adjustment unit to the center of the laser receiving unit is less than 1 mm.

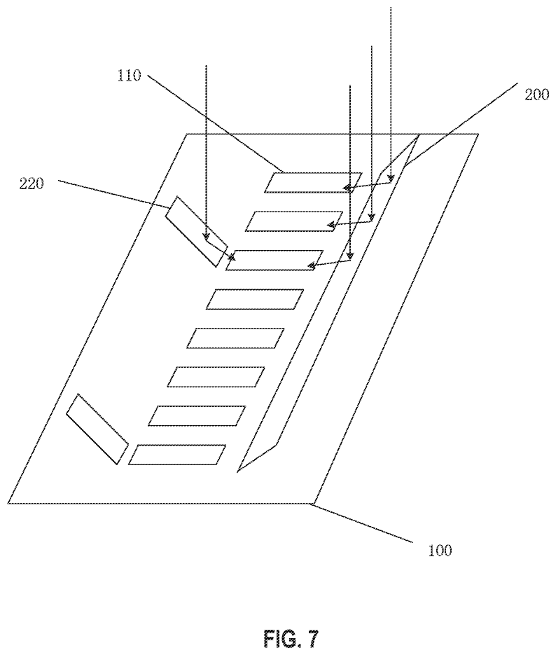

Further, as shown in FIG. 7, the laser receiving device may comprise a first laser receiving array. The first laser receiving array includes the plurality of laser receiving units 110. The laser receiving array is formed by one row or a plurality of rows of laser receiving units arranged on the laser receiving plate 100 by the plurality of rows of laser receiving units 110 according to the position of the emitting unit of the LiDAR. When arranged as the laser receiving array, the first receiving optical adjustment unit 200 is arranged on the first side of the laser receiving array for adjusting emission directions of laser beams entering the surface of the first receiving optical adjustment unit 200 to the plurality of the laser receiving units of the laser receiving array. The first receiving optical adjustment unit 200 may be arranged in a plurality of ways.

As shown in FIG. 7, when the first receiving optical adjustment unit 200 is provided as a whole, the first receiving optical adjustment unit 200 is arranged along the first laser receiving array. The length of the projection of the optical surface of the first receiving optical adjustment unit 200 on the laser receiving plate along the laser receiving array is greater than or equal to the total arrangement length of all laser receiving units in the laser receiving array. That is, the first receiving optical adjustment unit 200 is arranged as a whole on one side of the laser receiving array. In addition, to adjust all echo laser signals entering one side of the laser receiving array to the surface of the laser receiving array as much as possible, the length of the first receiving optical adjustment unit 200 is greater than or equal to the length of the laser receiving array. Meanwhile, in some embodiments, to enhance the receiving effect of the laser receiving unit, the second receiving optical adjustment unit 220 is provided on the second side of at least one laser receiving unit in the first laser receiving array. The second side of the laser receiving unit is a side opposite to the first receiving optical adjustment unit of the laser receiving unit. In this way, the echo laser signals may be adjusted from a plurality of directions, so that the echo laser signals enter the surface of the laser receiving unit, thereby improving the receiving effect of the echo laser.

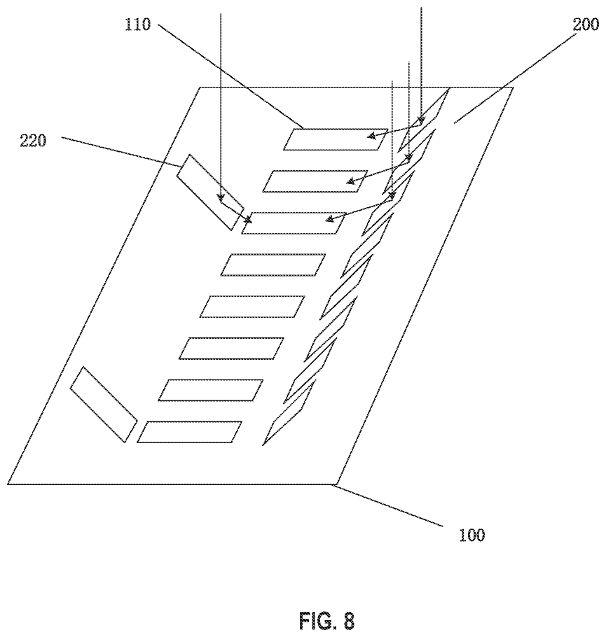

As shown in FIG. 8, because the emitting optical path of each transmitter is not completely the same, it is optimal that an angle of the first receiving optical adjustment unit 200 corresponding to each receiver is arranged to be finely adjustable. In the embodiment of this application, the plurality of first receiving optical adjustment units 200 is provided. The plurality of first receiving optical adjustment units 200 have one-to-one correspondence to the plurality of laser receiving units 110 in the first laser receiving array for adjusting emission directions of laser beams entering each optical reflecting surface of the plurality of first receiving optical adjustment units 200 to each laser receiving unit 110 in the first laser receiving array. In this way, because the plurality of first receiving optical adjustment units 200 are independently arranged, the angle of the first receiving optical adjustment unit 200 relative to the receiving unit is adjusted according to a divergence angle of the echo laser corresponding to each laser receiving unit, thereby better enhancing the receiving effect of the echo laser signals, achieving precise control, and greatly improving the receiving efficiency of each laser receiving unit. When a certain laser receiving unit fails, the first receiving optical adjustment unit 200 may be replaced and adjusted separately. Meanwhile, in some embodiments, the second receiving optical adjustment unit 220 can also be provided on the second side of at least one laser receiving unit 110 in the first laser receiving array. The second side of the laser receiving unit 110 is a side opposite to the first receiving optical adjustment unit 200 of the laser receiving unit. In this way, the echo laser signals may be adjusted from a plurality of directions, so that the echo laser signals enter the surface of the laser receiving unit, thereby improving the receiving of the echo laser.

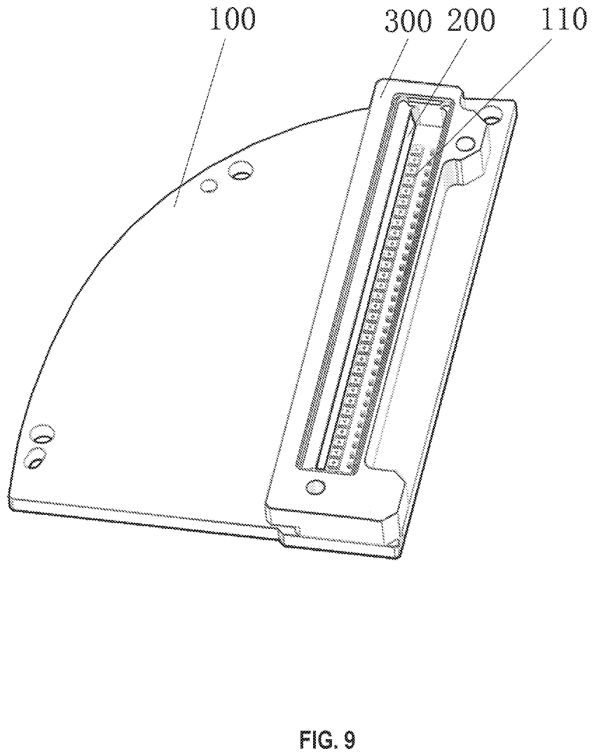

Further, to make the structure of the laser receiving device more compact, the laser receiving unit further includes an optical grating 300. As shown in FIG. 9, the optical grating 300 is arranged at the front side of the laser receiving plate on the echo laser optical path for preventing optical crosstalk among channels when the laser receiving unit receives the laser signals. The optical grating 300 is hollow inside and arranged on the laser receiving plate 100. The laser receiving array 110 is positioned in a hollow structure of the optical grating 300. The first receiving optical adjustment unit 200 is fixed in the hollow structure of the optical grating 300. The echo laser is received by the receiving unit via the hollow structure. The optical grating 300 is fixed on the laser receiving plate 100 by a screw or other means. The optical surface of the first receiving optical adjustment unit 200 is arranged inside the hollow structure, and may be fixed by pasting or other means. Further, to filter the echo laser signals, a light filter is provided on a laser receiving optical grating. The light filter is configured to filter incident laser and then shoot the incident laser to the laser receiving unit.

In practical applications, because an emitting angle of the laser emitting unit of each LiDAR is different, it is necessary to adjust the inclination angle of the first receiving optical adjustment unit 200 when each LiDAR is initialized. According to the embodiment of the present disclosure, to facilitate operation, the reflecting surface of the first receiving optical adjustment unit 200 is further arranged on one support member, and two ends of the support member are provided with fastening assemblies. The fastening assembly is configured to fix the support member on both ends of the optical grating. The fastening assembly is adjustable. The inclination angle of the reflecting surface is adjusted and hence fixed. Both ends of the optical grating are provided with fixing holes. The fastening assembly is arranged in the fixing holes. When the inclination angle of the first receiving optical adjustment unit 200 needs to be adjusted, the angle of the fastening assembly is adjusted at the two ends of the optical grating via the fixing hole, and then the inclination angle of the reflecting surface is further adjusted. In addition, in the embodiment of the present disclosure, to filter incident light entering the laser receiving unit, the light filter is arranged on the optical grating. The incident light is filtered and then shot to the laser receiving unit. In the embodiment of the present disclosure, the support member is provided for the first receiving optical adjustment unit 200 to more conveniently make the adjustment, thereby improving the usability of a product.

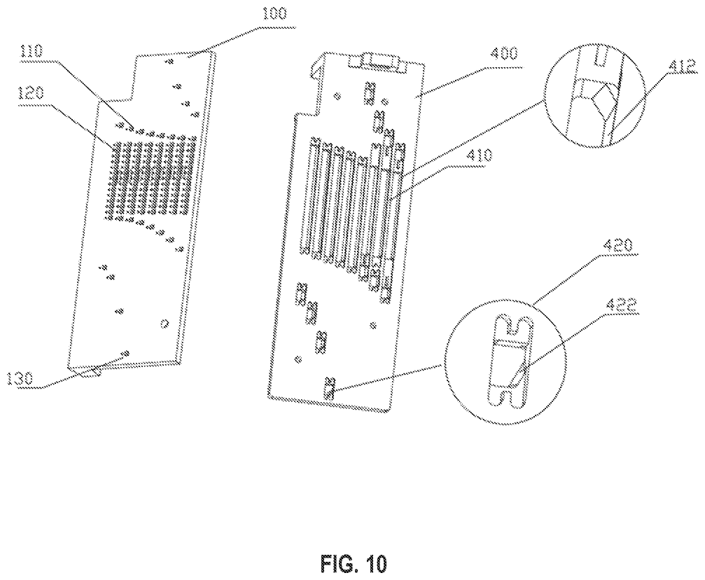

As shown in FIG. 10, another embodiment of the present application provides another laser receiving device, comprising a laser receiving plate 100, at least two laser receiving arrays 120, at least two optical adjustment units, and a laser receiving optical grating 400. The at least two laser receiving arrays 120 are arranged on the surface of the laser receiving plate 100 for receiving echo laser signals. The at least two optical adjustment units have one-to-one correspondence to the at least two laser receiving arrays 120 for adjusting emission directions of laser beams entering each optical surface of the at least two optical adjustment units to the laser receiving array 120 corresponding to each optical surface. In the embodiment of the present application, for each laser receiving array, different optical adjustment units are provided, respectively. Each of the at least two optical adjustment units includes at least one optical surface. An inclination angle of the optical surface of the optical adjustment unit corresponding to each laser receiving array of the at least two laser receiving arrays in a horizontal direction is different.

As shown in FIG. 10, the laser receiving array 120 includes a plurality of laser receiving units 110. The laser receiving device includes a third receiving optical adjustment unit 422. The at least two optical adjustment units comprise the third receiving optical adjustment unit 422. The third receiving optical adjustment unit 422 forms a third preset angle with a plane where the laser receiving plate is positioned. The third receiving optical adjustment unit 422 forms a fourth preset angle with a second vertical plane perpendicular to the laser receiving plate for adjusting the echo laser whose vertical divergence angle is greater than the first preset value in the echo laser.

As shown in FIG. 10, the laser receiving array 120 may include a plurality of laser receiving units 110. The plurality of laser receiving units 110 are arranged on the surface of the laser receiving plate 100 for receiving laser signals. The laser receiving optical grating 400 is arranged on the laser receiving plate 100 and on the front side of the laser receiving plate on an echo laser optical path. The optical grating 400 is provided with a hollow structure. The echo laser passes through the hollow structure and is received by the laser receiving unit. The optical surfaces of the at least two optical adjustment units are arranged inside the hollow structure to process optical signals entering the laser receiving unit. On the laser receiving optical grating 400, the hollow structure 410 is provided at a place corresponding to the laser receiving array 120. A fourth receiving optical adjustment unit 412 is provided on the side of the hollow structure 410 parallel to the laser receiving array 120. The fourth receiving optical adjustment unit 412 forms an angle with the laser signal receiving surface of the laser receiving array 120 for reflecting the laser signals entering the surface of the fourth receiving optical adjustment unit 412 to the laser signal receiving surface of the laser receiving array 120.

Further, the laser receiving array 120 further includes a plurality of laser receiving units 130 discretely arranged on the edge of the laser receiving plate 100 for receiving laser signals on the edge of the laser receiving plate. A hollow structure 420 is arranged at a place of the laser receiving optical grating 400 corresponding the plurality of laser receiving units 130 discretely arranged on the edge of the laser receiving plate. The third receiving optical adjustment unit 422 is arranged in the hollow structure 420. The third receiving optical adjustment unit 422 forms the third preset angle with the plane where the laser receiving plate is positioned. In addition, the third receiving optical adjustment unit 422 forms the fourth preset angle with the second vertical plane perpendicular to the laser receiving plate for adjusting echo laser whose vertical divergence angle is greater than the first preset value. Because laser signals emitted by a laser device on the edge of a laser entitling plate at a laser entitling side have a larger divergence angle after being reflected by the object, at a laser receiving plate side, in addition to diverging the laser receiving units, the third receiving optical adjustment unit 422 is also arranged differently from that of the optical adjustment units corresponding to other laser receiving units. To reflect the laser signals diverged at the edge of the laser receiving unit to the greatest extent, the third receiving optical adjustment unit 422 forms an angle with the two adjacent sides of the surface of the laser receiving plate. That is, when the third receiving optical adjustment unit 422 is arranged by the laser receiving optical grating, the optical grating encloses the laser receiving unit 130. An upper terminal of the third receiving optical adjustment unit 422 is positioned at a corner of the optical grating. That is, one side of the upper terminal of the third receiving optical adjustment unit 422 is arranged on one side of the optical grating, and the other side of the upper terminal of the third receiving optical adjustment unit 422 is arranged on the other side of the optical grating. A lower terminal of the third receiving optical adjustment unit 422 is positioned at a corner of the laser receiving unit 130. Refer to FIG. 10 for an exemplary arrangement. Because of this arrangement, the optical signals in the two directions of the parallel side and the vertical side of the laser receiving unit 130 may be reflected to the laser receiving surface of the laser receiving unit 130.

In addition, in the embodiment of the present disclosure, to filter the incident light entering the laser receiving unit, a light filter is arranged on the laser receiving optical grating. The incident light is filtered and shot to the laser receiving unit.

In the embodiment of the present disclosure, it may be seen from the forgoing that owing to the arrangement of the optical adjustment unit for the laser receiving unit, a part of light deviating from the laser receiving unit is reflected into the photosensitive surface of a receiving sensor, thereby improving the receiving efficiency of the optical signals. Especially when the LiDAR scans an object at a close distance, the optical signals can be better received via the laser receiving device.

An optical system of the LiDAR may be divided into a coaxial system and an off-axis system. When an emitting optical system and a receiving optical system are off-axis systems, a near-field blind region is usually generated due to two reasons. On the one hand, when an emitting laser beam for detecting a long-distance also hits the object at a close distance and is reflected, because the emitting optical system and the receiving optical system are aligned at a long distance, an image point formed by the reflected signal light via a receiving lens is not on a focal plane of the receiving lens. At the same time, the reflected signals cannot be received by the receiver after the optical path is folded via a mirror of a receiving terminal. This problem may be solved by the forgoing embodiments. However, there is another situation. To meet the needs of distance measurement, the LiDAR needs to align a detection field of view of a laser emission beam with a receiving field of view of a detector at a long distance, which leads to no overlapped area at the emitting field of view and the receiving field of view at a close distance at all, thereby producing a blind region. Therefore, to solve the forgoing two problems at the same time, the present disclosure further provides the following embodiments to further solve the forgoing problems.

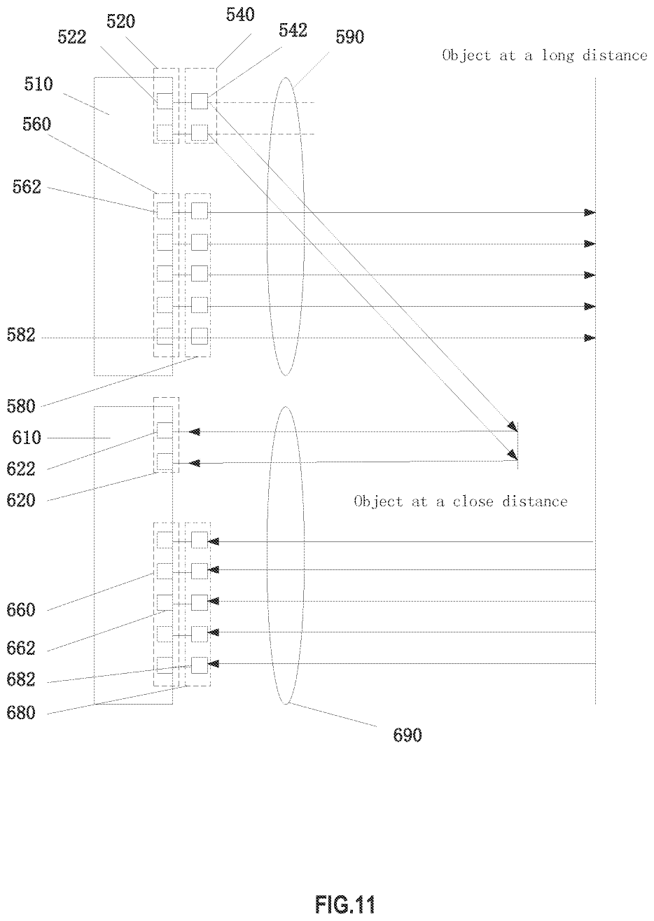

As shown in FIG. 11, an embodiment of the present disclosure also provides a LiDAR having a laser emitting device and a laser receiving device. The laser emitting device includes a laser emitting array 510, a first laser emitting unit group 520, and a first emitting optical adjustment unit group 540. The laser emitting array 510 includes the first laser emitting unit group 520. The first laser emitting unit group 520 includes a plurality of laser emitting units 522. The first emitting optical adjustment unit group 540 includes a plurality of first emitting optical adjustment units 542. The first emitting optical adjustment unit 542 in the first emitting optical adjustment unit group 540 has one-to-one correspondence to the first laser emitting units 522 in the laser emitting unit group 520 for adjusting laser signals emitted by the first laser emitting unit 522 in the first laser emitting unit group 520. In this way, the detection field of view of the laser emitted by the first laser emitting unit group and its corresponding receiving field of view are intersected in a near field. It is understandable that the first emitting optical adjustment unit 540 is an optical element that may adjust an optical path. The first emitting optical adjustment unit 540 may be an optical wedge or a microprism, or a combination of the optical wedge or the microprisms and other optical elements. In the LiDAR in the prior art, the laser emitting unit is often arranged together with a collimating optical adjustment unit, such as a collimating optical element, which collimates an emitted laser, so that the entire emitting device is highly integrated and has a simple structure. In some embodiments, the first emitting optical adjustment unit 542 in the first emitting optical adjustment unit group 540 is configured as the collimating optical element, such as a collimating lens. The emitting optical axes of the plurality of first laser emitting units 522 of the first laser emitting unit group 520 are not overlapped with the optical axes of the first emitting optical adjustment unit 542 corresponding thereto. Therefore, the optical path of laser signals emitted by the first laser emitting unit 522 may be adjusted to maximize the use of components of the LiDAR in the prior art. The arrangement of the optical axes of the first emitting optical adjustment unit 542 and the first laser emitting unit 522 that are not overlapped is achieved by arranging the optical axis of the collimator lens and the emitting optical axis of the first laser emitting unit at an angle.

The laser receiving device includes a laser receiving plate, a laser receiving array 610, and a first laser receiving unit group 620. The laser receiving array 610 includes the first laser receiving unit group 620. The first laser receiving unit group 620 includes a plurality of first laser receiving units 622. The plurality of first laser receiving units 622 are arranged on the surface of the laser receiving plate, and are correspondingly arranged with the plurality of first laser emitting units 522 of the first laser emitting unit group 520 for receiving an adjusted echo laser signals. It should be noted that the first laser receiving unit group 620 is a laser receiving unit added based on the forgoing embodiment of the laser receiving device for receiving laser signals emitted by the first laser emitting unit group of the laser emitting device.

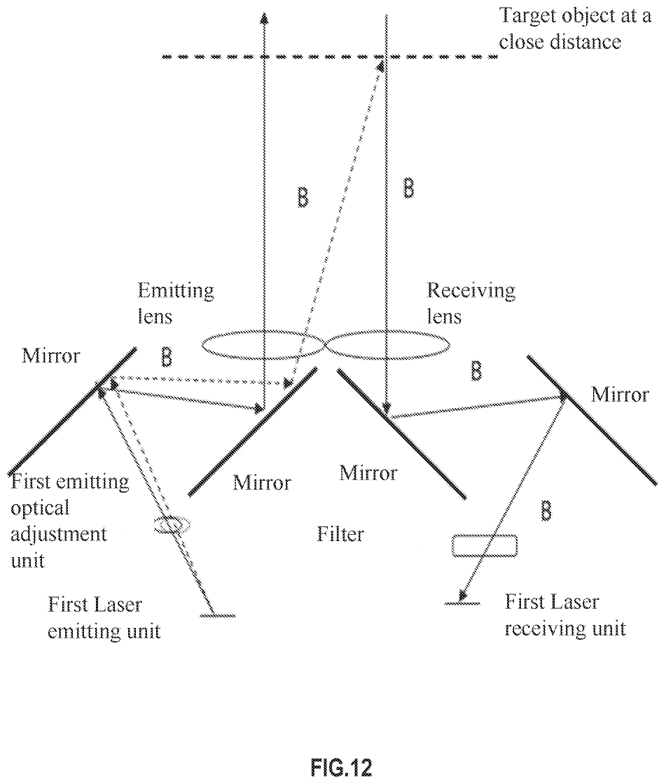

FIG. 12 shows an optical path diagram of the laser receiving device. At an emitting terminal, the first laser emitting optical adjustment unit is arranged in front of the first laser emitting unit in the LiDAR. The emission directions of the laser signals emitted by the first laser emitting unit that needs to detect an object at a close distance are adjusted. The emitted laser signals are adjusted to laser signals B. The laser signals B are reflected by a double mirror, pass through an emission lens, and are shot to a target object at a close distance. The target object at a close distance reflects the laser signals B to a receiving lens of the laser receiving device.

At a receiving terminal, the laser signals B adjusted by the first emitting optical adjustment unit receive the echo laser signals via a laser receiving lens. A mirror enters the adjusted laser signals B to the first laser receiving unit.

Because the laser signals emitted by the first laser emitting unit are adjusted via the first emitting optical adjustment unit at the emitting terminal, the adjusted echo laser signals may also be reflected to the first laser receiving unit at the receiving terminal after being reflected by the object at the close distance, thereby improving the detection effect of the LiDAR on the object at the close distance.

Further, referring to FIG. 11 again, the laser emitting array 510 includes a second laser emitting unit group 560 and a second emitting optical adjustment unit group 580. The second laser emitting unit group 560 includes at least one second laser emitting unit 562. The second emitting optical adjustment unit group 580 includes at least one second emitting optical adjustment unit 582. The second emitting optical adjustment unit 582 in the second emitting optical adjustment unit group 580 is correspondingly arranged with the second laser emitting unit 562 in the second laser emitting unit group 560 for collimating laser signals emitted by the second laser emitting unit 562 in the second laser emitting unit group 560 and shooting the laser signals to an object at a long distance.

The laser receiving array 610 further includes a second laser receiving unit group 660 and a fifth receiving optical adjustment unit group 640. The second laser receiving unit group 660 includes a plurality of second laser receiving units 662. The fifth receiving optical adjustment unit group 640 includes a plurality of fifth receiving optical adjustment units 642. The fifth receiving optical adjustment unit 642 is arranged on the first side of the second laser receiving unit 662 for adjusting the direction of the echo laser signals entering the optical surface of the fifth receiving optical adjustment unit 642 to the second laser receiving unit 662. The second laser receiving unit group 660 is configured to receive laser signals emitted by the second laser emitting unit group 560, that is, the second laser receiving unit group 660 receives the laser signals emitted after collimation. The fifth receiving optical adjustment unit 642 is configured to adjust the echo laser to be able to be received by the second laser receiving unit 662 of the second laser receiving unit group 660 when the emitted laser light of the emitting unit in the second laser emitting unit group 560 hits an obstacle at the near field, so that the emitted laser of the second laser emitting unit group may also detect the objects at the close distance. It should be noted that the structure and working principle of the second laser receiving unit group 660 are the same as those of the laser receiving unit mentioned in the foregoing embodiments of the laser receiving device.

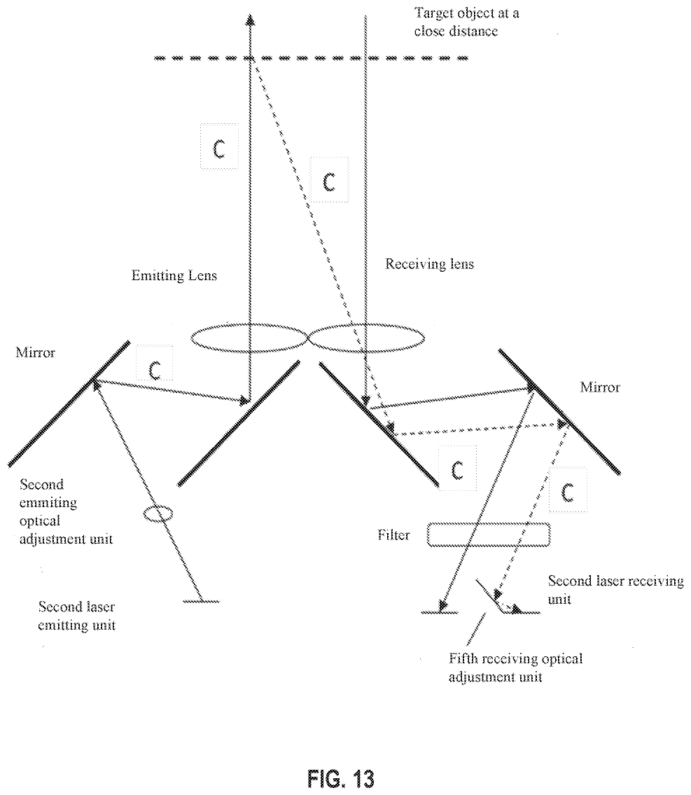

FIG. 13 shows an optical path diagram of the laser receiving device. At the emitting terminal, the LiDAR collimates the laser signals emitted by the second laser emitting unit by arranging the second emitting optical adjustment unit in front of the second laser emitting unit to form an emitting laser C. The laser signals C are reflected by the mirror, pass through the emitting lens, and are shot to the target object at the close distance to be measured.

At the receiving terminal, the target object at the close distance reflects the laser signals C to the receiving lens of the laser receiving device, and enters the laser signals C to the second laser receiving unit of the receiving terminal via the receiving lens. The echo laser signals reflected by the object at the close distance deviates from the second laser receiving unit and enters the fifth receiving optical adjustment unit. The fifth receiving optical adjustment unit reflects the echo laser signals to the receiving surface of the second laser receiving unit.

It is understandable that when a laser emitter of the laser emitting array 510 is an edge emitter, the plurality of laser emitting arrays 510 may be fixed on the plurality of laser emitting plates. It is understandable that the plurality of laser receiving arrays 610 may be fixed on the plurality of receiving plates or one receiving plate. The laser emitting array 510 and the laser receiving array 610 satisfy one-to-one arrangement relationship. Because the laser signals emitted by the second laser emitting unit are collimated at the emitting terminal via the second emitting optical adjustment unit, the collimated echo laser signals are reflected by the object at the close distance to the fifth receiving optical adjustment unit of the receiving terminal. The fifth receiving optical adjustment unit reflects the echo laser signals to the receiving surface of the second laser receiving unit, thereby improving the detection effect of the LiDAR on the object at the close distance.

In summary, the LiDAR provided in the embodiments of the present disclosure processes the signals at the near field at the emitting terminal and the corresponding echo laser signals at the receiving terminal, respectively, which greatly improves the LiDAR's ability to detect the object at the near field.

An embodiment of the present disclosure further provides an intelligent induction apparatus, including at least one LiDAR. The LiDAR includes a laser receiving device in the forgoing embodiments. The function and structure of the laser receiving device are the same as those in the forgoing embodiments. The description is not repeated here.

It should he noted that unless otherwise specified, the technical or scientific terms used in the embodiments of the present disclosure should have general meanings understood by a person of ordinary skill in the art to which the embodiments of the present disclosure belong.

In the description of embodiments of this implementation, orientations or position relationships indicated by the technical terms such as “center,” “longitudinal,” “lateral,” “length,” “width,” “thickness,” “above,” “under,” “front,” “rear,” “left,” “right,” “vertical,” “horizontal,” “top,” “bottom,” “inner,” “outer,” “clockwise,” “counterclockwise,” “axial,” “radial,” and “circumferential” are based on the orientations or position relationships shown in the drawings, are merely intended to describe the present disclosure and simplify the descriptions, but are not intended to indicate or imply that the indicated device or element shall have a specific orientation or he formed and operated in a specific orientation, and therefore cannot be understood as a limitation on the embodiments of the present disclosure.

In addition, the technical terms such as “first” and “second” are merely intended for an objective of description, and shall not be understood as an indication or implication of relative importance or an implicit indication of a quantity of indicated technical features. In the description of the embodiments of the present disclosure, “a plurality of” means two or more, unless otherwise specifically defined.

In the description of embodiments of this implementation, unless otherwise clearly specified and limited, the technical terms such as “mounting,” “connected,” “connection,” and “fixing” shall be understood in a general sense. For example, these technical terms may be a fixed connection, a detachable connection, or an integrated connection; or may be a mechanical connection or an electrical connection; or may be a direct connection, an indirect connection by using an intermediate medium, or an internal communication of two elements or an interaction of two elements. A person of ordinary skill in the art may understand specific meanings of the foregoing terms in the embodiments of the present disclosure according to a specific situation.

In the description of embodiments of this implementation, unless otherwise clearly specified and defined, that a first feature is “above” or “under” a second feature may be that the first feature and the second feature are in direct contact, or that the first feature and the second feature are in indirect contact through an intermediate medium. Moreover, that a first feature is “above,” “over,” and “on” a second feature may be that the first feature is right above or diagonally above the second feature, or may merely indicate that a horizontal height of the first feature is greater than that of the second feature. The arrangement that a first feature is “below,” “underneath,” and “under” a second feature may be the arrangement that the first feature is right below or diagonally below the second feature, or may merely indicate that a horizontal height of the first feature is less than that of the second feature.

Finally, it should be noted that the foregoing embodiments are intended for describing instead of limiting the technical solutions of the present disclosure. Although the present disclosure is described in detail with reference to the foregoing embodiments, the person skilled in the art should understand that modifications may be made to the technical solutions described in the foregoing embodiments or equivalent replacements may be made to some or all technical features thereof. These modifications or replacements shall not depart from the scope of the technical solutions and shall fall in the scopes of claims and the specification. Particularly, the technical features mentioned in the embodiments may be combined in any manner, provided that no structural conflict occurs. The present disclosure is not limited to the embodiments disclosed in this specification, but includes all technical solutions that fail within the scope of the claims.

What is claimed is:

1. A laser receiving device, comprising: a laser receiving plate, a laser receiving unit, and a first receiving optical adjustment unit,
wherein the laser receiving unit is arranged on a surface of the laser receiving plate for receiving echo laser signals, and the first receiving optical adjustment unit is arranged on a first side of the laser receiving unit for adjusting emission directions of laser beams entering an optical surface of the first receiving optical adjustment unit to the laser receiving unit.

2. The laser receiving device according to claim 1, wherein the first receiving optical adjustment unit forms a first preset angle with a plane where the laser receiving plate is positioned.

3. The laser receiving device according to claim 2, wherein the first receiving optical adjustment unit forms a second preset angle with a first vertical plane perpendicular to the laser receiving plate.

4. The laser receiving device according to claim 1, wherein the first receiving optical adjustment unit is an optical reflecting unit, and the optical reflecting unit comprises a reflecting plane or a reflecting concave surface.

5. The laser receiving device according to claim 1, wherein the laser receiving device comprises a first laser receiving array, and the first laser receiving array comprises a plurality of laser receiving units,
the first receiving optical adjustment unit is arranged on a first side of the first laser receiving array for adjusting emission directions of laser beams entering a surface of the first receiving optical adjustment unit to the plurality of laser receiving units of the first laser receiving array.

6. The laser receiving device according to claim 5, wherein the laser receiving device further comprises a second receiving optical adjustment unit,
the second receiving optical adjustment unit is arranged on a second side of at least one of the plurality of laser receiving units in the first laser receiving array, and the second side of at least one of the plurality of laser receiving units is a side opposite to the first receiving optical adjustment unit of the laser receiving unit.

7. The laser receiving device according to claim 5, wherein a number of the first receiving optical adjustment unit is one or more,
when one first receiving optical adjustment unit is provided, the first receiving optical adjustment unit is arranged along the first laser receiving array, and a length of a projection of the optical surface of the first receiving optical adjustment unit on the laser receiving plate along the first laser receiving array is greater than or equal to a total arrangement length of all laser receiving units in the first laser receiving array; and
when a plurality of first receiving optical adjustment units are provided, the plurality of first receiving optical adjustment units have one-to-one correspondence to the plurality of laser receiving units in the first laser receiving array for adjusting the emission directions of laser beams entering each optical reflecting surface of the plurality of first optical units to each laser receiving unit in the first laser receiving array.

8. The laser receiving device according to claim 1, wherein an inclination angle of an optical surface of the first receiving optical adjustment unit relative to the laser receiving plate in a horizontal direction is not less than 100 degrees and not more than 115 degrees.

9. The laser receiving device according to claim 8, wherein a distance from the first receiving optical adjustment unit to a center of the laser receiving unit is less than 1 mm.

10. The laser receiving device according to claim 1, wherein the laser receiving unit further comprises an optical grating, and the optical grating is arranged on a front side of the laser receiving plate on an echo laser optical path for preventing optical crosstalk generated when the laser receiving unit receives laser signals;
a hollow structure is arranged on the optical grating, and echo laser is received by the receiving unit via the hollow structure; and
the optical surface of the first receiving optical adjustment unit is arranged inside the hallow structure.

11. The laser receiving device according to claim 10, wherein a light filter is arranged on a laser receiving optical grating; and
the light filter is configured to filter incident laser and shoot the incident laser to the laser receiving unit.

12. A laser receiving device, comprising: a laser receiving plate, at least two laser receiving arrays, and at least two optical adjustment units,
wherein the at least two laser receiving arrays are arranged on a surface of the laser receiving plate for receiving echo laser signals; and
the at least two optical adjustment units have one-to-one correspondence to the at least two laser receiving arrays for adjusting emission directions of laser beams entering each optical surface of the at least two optical adjustment units to each laser receiving array corresponding to each optical surface.

13. The laser receiving device according to claim 12, wherein each of the at least two optical adjustment units comprises at least one optical surface, and an inclination angle of the optical surface of the optical adjustment unit corresponding to each laser receiving array of the at least two laser receiving arrays in a horizontal direction is different.

14. The laser receiving device according to claim 12, wherein each laser receiving array comprises a plurality of laser receiving units,
the laser receiving device comprises a third receiving optical adjustment unit; and
the at least two optical adjustment units comprise the third receiving optical adjustment unit,
wherein the third receiving optical adjustment unit forms a third preset angle with a plane where the laser receiving plate is positioned, and the third receiving optical adjustment unit forms a fourth preset angle with a second vertical plane perpendicular to the laser receiving plate for adjusting echo laser whose vertical divergence angle is greater than a first preset value in the echo laser.

15. The laser receiving device according to claim 12, wherein the laser receiving device further comprises an optical grating,
the optical grating is arranged on a front side of the receiving plate on an echo laser optical path, a hollow structure is arranged on the optical grating, and the echo laser is received by the receiving unit via the hollow structure; and
the optical surfaces of the at least two optical adjustment units are arranged inside the hollow structure.

16. The laser receiving device according to claim 15, wherein a light filter is arranged on a laser receiving optical grating,
the light filter is configured to filter incident laser and shoot the incident laser to the laser receiving unit.

17. A LiDAR, comprising a laser emitting device and a laser receiving device according to claim 12,
wherein the laser emitting device comprises at least two laser emitting arrays; and
the at least two laser emitting arrays have one-to-one correspondence to the at least two laser receiving arrays of the laser receiving device.

18. The LiDAR according to claim 17, wherein the laser emitting device comprises a first emitting optical adjustment unit;
the laser emitting array comprises a plurality of first laser emitting units;
the plurality of first laser emitting units are arranged at an edge of the laser emitting plate for emitting laser signals; and
the plurality of first emitting optical adjustment units are arranged in front of the plurality of first laser emitting units respectively for adjusting emission directions and emission angles of the laser signals emitted by the first laser emitting unit.
